(19) United States
(12) Patent Application Publication
(10) Pub. No.: US 2019/0205847 A1
(43) Pub. Date: Jul. 4, 2019

(54) PARKING PREVENTION APPARATUS, MOBILE TERMINAL, AND PARKING PREVENTION SYSTEM HAVING SAME

(71) Applicant: LG ELECTRONICS INC., Seoul (KR)

(72) Inventors: Youngjoo CHO, Seoul (KR); Jeongwoo KIM, Seoul (KR)

(73) Assignee: LG ELECTRONICS INC., Seoul (KR)

(21) Appl. No.: 16/330,482

(22) PCT Filed: Jul. 11, 2017
(86) PCT No.: PCT/KR2017/007390

§ 371 Date: Mar. 5, 2019

(30) Foreign Application Priority Data
Sep. 5, 2016 (KR) 10-2016-0113912

(51) Int. Cl. G06Q 20/10; G06Q 20/14; E01F 13/08; E01F 13/12; G08G 1/14; G06Q 50/30

(52) U.S. Cl. CPC G06Q 20/102; G06Q 20/145; E01F 13/085; G06Q 2240/00; G08G 1/144; G06Q 50/30; E01F 13/12

(57) ABSTRACT

The present invention relates to a parking prevention device, a mobile terminal, and a parking prevention system having the same. A parking prevention device according to one embodiment of the present invention comprises: a rotary shaft arranged in a main body; a parking lock member which is connected to the rotary shaft and rotates; a parking lock operation unit for operating the rotary shaft for rotating the parking lock member; a communication unit for exchanging data with a repeater or a server; and a processor which controls the parking lock member to operate in a parking lock mode and, on the basis of a parking lock cancellation signal received from the repeater or the server, to controls the parking lock member to operate in a parking lock cancellation mode. Hence, the present invention can prevent an unpermitted parking and allow a permitted vehicle to park.

### TECHNICAL FIELD

The present invention relates to a parking prevention apparatus, a mobile terminal, and a parking prevention system having the same, and more particularly, to a parking prevention apparatus and a mobile terminal capable of preventing an unpermitted parking and allowing the parking of a permitted vehicle, and a parking prevention system having the same.

### BACKGROUND ART

As the number of vehicles increases, parking space becomes increasingly important.

Meanwhile, in the case of a residential area, in some cases, a residential parking permit privilege is given to a resident, and only a permitted vehicle is allowed to park.

However, in the case of a residential area, a large number of vehicles are parked in a parking area, mainly in the morning and evening, but only a part of the vehicles are parked in the daytime.

Accordingly, a method for utilizing a parking space around the residential area during the daytime is required. In addition, measures for preventing an unpermitted parking are also required.

### DISCLOSURE

### Technical Problem

The present invention has been made in view of the above problems, and provides a parking prevention apparatus and a mobile terminal capable of preventing an unpermitted parking and allowing the parking of a permitted vehicle, and a parking prevention system having the same.

### Technical Solution

In an aspect, there is provided a parking prevention apparatus, including: a rotary shaft disposed in a main body; a parking lock member connected to the rotary shaft and to rotate; a parking lock operation unit to operate the rotary shaft for rotating the parking lock member; a communication unit to exchange data with a repeater or a server; and a processor to control the parking lock member to operate in a parking lock mode and, based on a parking lock cancellation signal received from the repeater or the server, to control the parking lock member to operate in a parking lock cancellation mode.

In another aspect, there is provided a mobile terminal, including: a display; a communication unit to exchange data with a server; and a controller to control to display at least one parking prevention apparatus available for parking on the display based on selection signal, transmit parking availability information to the server when any one of the at least one parking prevention apparatus is selected, and transmit ID information to the server when receiving a beacon signal including the ID information from the selected parking prevention apparatus.

In another aspect, there is provided a parking prevention system, including: a mobile terminal to transmit parking availability information for using any one of at least one parking prevention to the outside; a server to transmit the parking availability information when receiving the parking availability information from the mobile terminal, and transmit a parking lock cancellation signal when receiving ID information of the parking prevention apparatus from the mobile terminal; and a parking prevention apparatus to transmit a beacon signal when receiving the parking availability information from the server or a repeater, and operate a parking lock member in a parking lock cancellation mode when receiving a parking lock cancellation signal from the server or the repeater.

### Advantageous Effects

A parking prevention apparatus according to an embodiment of the present invention includes: a rotary shaft disposed in a main body; a parking lock member connected to the rotary shaft and to rotate; a parking lock operation unit to operate the rotary shaft for rotating the parking lock member; a communication unit to exchange data with a repeater or a server; and a processor to control the parking lock member to operate in a parking lock mode and, based on a parking lock cancellation signal received from the repeater or the server, to control the parking lock member to operate in a parking lock cancellation mode, thereby preventing unpermitted parking and allowing a permitted vehicle to park.

Particularly, the parking lock member is automatically operated, thereby increasing the convenience of use.

Meanwhile, the processor controls to receive parking availability information from the repeater or server, and transmit a beacon signal including ID information after receiving the parking availability information, thereby enabling the parking lock member to operate in the parking lock cancellation mode when the permitted vehicle or the permitted mobile terminal approaches.

Meanwhile, the processor controls to extract parking use time information from the parking availability information when receiving the parking availability information from the repeater or server, perform communication with the repeater or the server every first period before a first time zone based on the parking use time information, and communicate with the repeater or the server every second period shorter than the first period in the first time zone, thereby reducing the power consumption.

Meanwhile, according to another aspect of the present invention, there is provided a mobile terminal including: a display; a communication unit to exchange data with a server; and a controller to control to display at least one parking prevention apparatus available for parking on the display based on selection signal, transmit parking availability information to the server when any one of the at least one parking prevention apparatus is selected, and transmit ID information to the server when receiving a beacon signal including the ID information from the selected parking prevention apparatus, thereby preventing unpermitted parking and allowing a permitted vehicle to park.

Meanwhile, after any one of the at least one parking prevention apparatus is selected, when the payment is completed, the mobile terminal transmits the parking availability information and the payment information to the server, so that the server may process the permission for the mobile terminal.

Meanwhile, according to another aspect of the present invention, there is provided a parking prevention system including: a mobile terminal to transmit parking availability information for using any one of at least one parking prevention to the outside; a server to transmit the parking availability information when receiving the parking availability information from the mobile terminal, and transmit a parking lock cancellation signal when receiving ID information of the parking prevention apparatus from the mobile terminal; and a parking prevention apparatus to transmit a beacon signal when receiving the parking availability information from the server or a repeater, and operate a parking lock member in a parking lock cancellation mode when receiving a parking lock cancellation signal from the server or the repeater, thereby preventing unpermitted parking and allowing a permitted vehicle to park.

### DESCRIPTION OF DRAWINGS

FIG. 1 is a diagram illustrating a parking prevention system according to an embodiment of the present invention.

FIG. 2 is a diagram illustrating a parking prevention apparatus disposed in a parking space around a residential area.

FIG. 3A and FIG. 3B are diagrams for explaining the operation of a parking prevention apparatus of FIG. 1.

FIG. 4 is a simplified internal block diagram of a parking prevention apparatus of FIG. 1.

FIG. 5A to FIG. 5C are diagrams for explaining the operation of a parking prevention apparatus.

FIG. 6 is a simplified internal block diagram of a server of FIG. 1.

FIG. 7 is an example of an internal block diagram of a mobile terminal of FIG. 1.

FIG. 8 is a flowchart illustrating an operation method of a parking prevention system according to an embodiment of the present invention.

FIG. 9A to FIG. 11B are diagrams for explaining the operation method of a plant grower of FIG. 8.

FIG. 12 is a flowchart illustrating an operation method of a parking prevention system according to another embodiment of the present invention.

### MODE FOR INVENTION

Hereinafter, preferred embodiments of the present invention will be described with reference to the accompanying drawings. With respect to constituent elements used in the following description, suffixes “module” and “unit” are given only in consideration of ease in the preparation of the specification, and do not have or serve as different meanings. Accordingly, the suffixes “module” and “unit” may be used interchangeably.

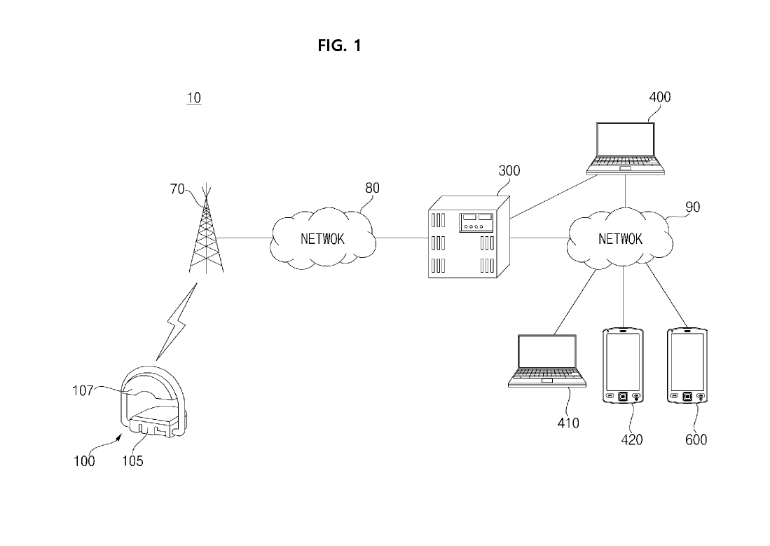

FIG. 1 is a view showing a parking prevention system according to an embodiment of the present invention.

Referring to the drawing, a parking prevention system 10 of FIG. 1 is an unmanned automated parking prevention system, and may include a parking prevention apparatus 100 disposed in a residential area, a mobile terminal 600 of a user who desires to use the parking prevention apparatus, and a server 300 for remotely controlling the parking prevention apparatus 100.

Meanwhile, in the parking prevention system 10 of FIG. 1, the parking prevention apparatus 100 and the server 300 may perform a low power long range (LoRa) communication that may accomplish a communication even at a distance of about 10 to 20 Km.

Meanwhile, in the parking prevention system 10 of FIG. 1, a repeater 70 may be disposed to perform a long range communication of 20 Km or more.

In the drawing, the repeater 70 and a network 80 are disposed between the parking prevention apparatus 100 and the server 300, but alternatively, various modifications such as direct communication are possible.

Meanwhile, the parking protection system 10 of FIG. 1 may further include a control apparatus 400 for exchanging data with the server 300 and receiving state information or operation information of the parking prevention apparatus 100 to perform remote failure diagnosis.

Meanwhile, the parking protection system 10 of FIG. 1 may further include a second control apparatus 410 for receiving state information or operation information of the parking prevention apparatus 100 and remotely authorizing a right to the use of the parking prevention apparatus 100.

At this time, the second control apparatus 410 may be a server, or the like in a local public institution that owns the right to the parking prevention apparatus 100 disposed in a residential area, for example, a server in a village office or a server in a ward office.

Meanwhile, the parking prevention system 10 of FIG. 1 may further include a parking manager terminal 420 for managing the parking prevention apparatus 100.

Meanwhile, in the drawing, it is illustrated that the control apparatus 400, the second control apparatus 410, the parking manager terminal 420, and a mobile terminal 600 of a user of the parking prevention apparatus are connected to the server 300 through a network 90. However, various modifications are possible.

Meanwhile, the mobile terminal 600 may display at least one parking prevention apparatus available for parking on a display 680 based on user input, and transmit parking availability information to the server 300 when any one of the at least one parking prevention apparatus is selected.

In particular, when a payment is completed, the mobile terminal 600 may transmit payment information to the server 300 together with the parking availability information.

Alternatively, when the payment is completed in the mobile terminal 600, a payment server may transmit the payment information to the repeater 70 or the server 300.

When the server 300 receives the parking availability information and the payment information, the server 300 may transmit the parking availability information to the parking prevention apparatus 100. At this time, the parking availability information may be transmitted through a LoRa communication method.

The parking availability information may include selected parking prevention apparatus information and selected parking use time information for using the selected parking prevention apparatus information.

In addition, the parking availability information may further include payment completion information.

Meanwhile, the parking prevention apparatus 100 may receive the parking availability information from the server 300 or the repeater 70.

The parking prevention apparatus 100 may extract parking use time information from the received parking availability information.

Then, the parking prevention apparatus 100 may transmit a beacon signal including ID information of the parking prevention apparatus to the outside.

Particularly, the parking prevention apparatus 100 may transmit the beacon signal including the ID information of the parking prevention apparatus to the outside during a predetermined time zone corresponding to the extracted parking use time information.

Meanwhile, when a vehicle user approaches the parking prevention apparatus 100 while carrying the mobile terminal 600, the mobile terminal 600 may receive the beacon signal. Then, the mobile terminal 600 may transmit the ID information of the parking prevention apparatus 100 included in the beacon signal to the server 300.

Meanwhile, the parking prevention apparatus 100 may exchange data with the server 300 periodically.

For example, the parking prevention apparatus 100 may exchange data with the server 300 through uplink and downlink every first period. For example, the first period may be approximately two minutes. As described above, since data is exchanged with the server 300 every first period, unnecessary power consumption may be reduced.

Meanwhile, the parking prevention apparatus 100 may exchange data with the server 300 through uplink and downlink every second period shorter than the first period, during a predetermined time zone corresponding to the extracted parking use time information. For example, the second period may be approximately 10 seconds.

Meanwhile, as described above, when the vehicle user approaches the parking prevention apparatus 100 while carrying the mobile terminal 600, that is, when the vehicle approaches the parking prevention apparatus 100, the server 300 may transmit a parking lock cancellation signal to the parking prevention apparatus 100, based on the ID information received from the mobile terminal 600.

Thus, the parking prevention apparatus 100 may receive the parking lock cancellation signal, convert a parking lock mode to a parking lock cancellation mode based on the parking lock cancellation signal, and enable a parking lock member 107 to operate in the parking lock cancellation mode.

Thus, the vehicle user may park a vehicle in a parking area where the parking prevention apparatus 100 is positioned.

Thus, the permission with respect to the parking prevention apparatus 100 may be remotely performed, so that an unmanned parking permission for the permitted vehicle may be performed to prevent unpermitted parking.

In particular, in the case of a residential area or the like where the utilization rate is low during the daytime, the user convenience may be increased by implementing the system 10 including such a parking prevention apparatus 100.

Meanwhile, when an application using the parking prevention apparatus 100 is not installed in the mobile terminal 600, a user may call a public office or the like having a right to the parking management apparatus 100.

Accordingly, a call center received the call may transmit the parking availability information to the server 300. Accordingly, the server 300 may transmit the parking availability information to a corresponding parking prevention apparatus 100, and subsequent operations may be the same as described above.

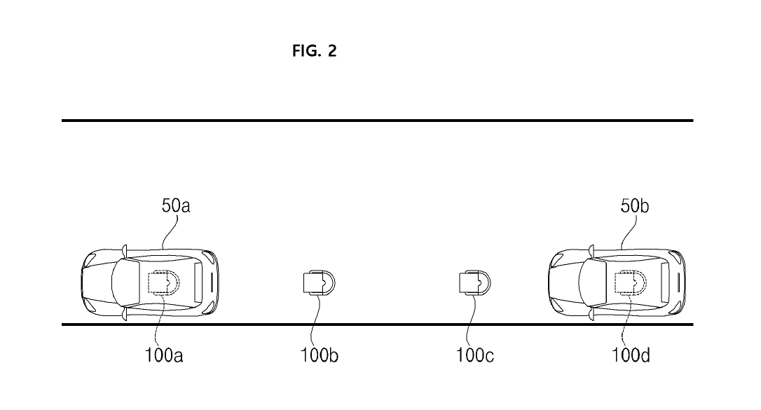

FIG. 2 is a diagram illustrating a parking prevention apparatus disposed in a parking space around a residential area.

The parking prevention apparatus 100 according to an embodiment of the present invention may be installed in a residential parking permit area of a side street in a residential area.

FIG. 2 illustrates that a plurality of parking prevention apparatuses 100a to 100d are installed in a plurality of parking areas respectively and, among the plurality of parking prevention apparatuses, first and fourth parking prevention apparatuses 100a and 100d operate in a parking lock cancellation mode and vehicles 50a and 50b are parked respectively.

Meanwhile, it is illustrated that the second and third parking prevention apparatuses 100b and 100c operate in a parking lock mode.

When such a plurality of parking prevention apparatuses 100a to 100d are installed in a residential area where the utilization rate is low during the daytime, a parking space may be efficiently used.

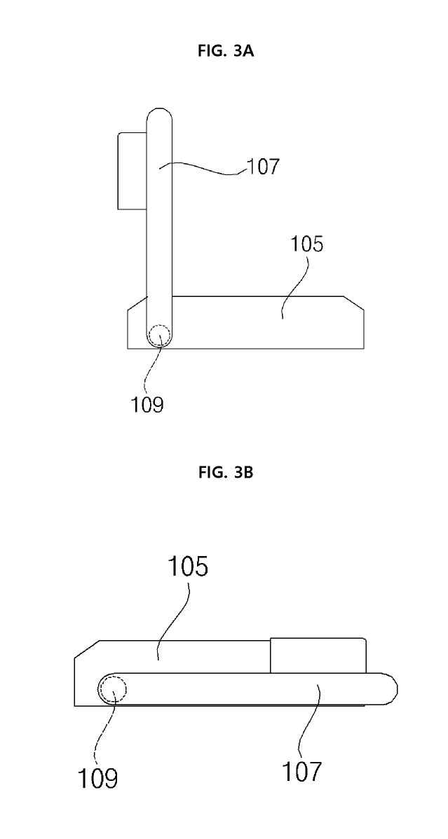

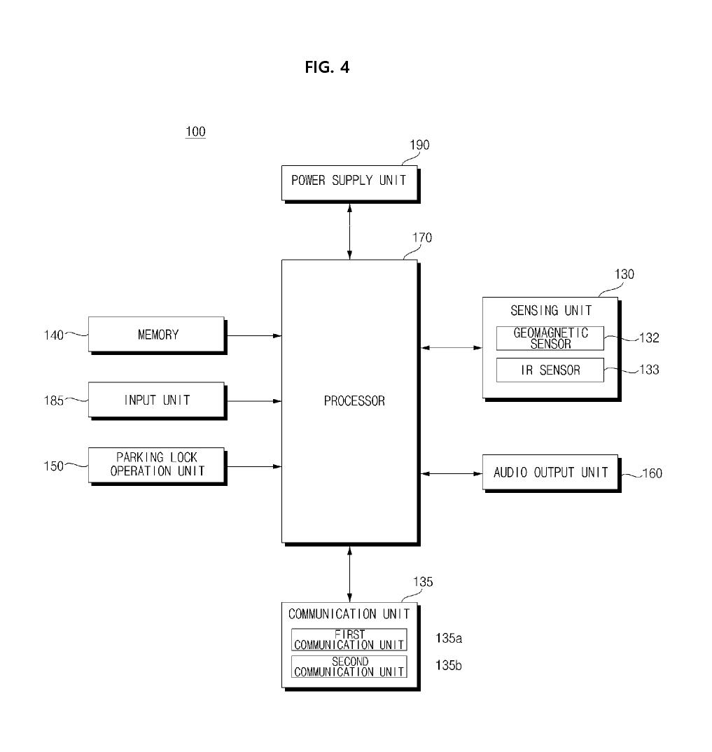

FIG. 3A and FIG. 3B are diagrams for explaining the operation of the parking prevention apparatus of FIG. 1.

Referring to the drawings, the parking prevention apparatus 100 may include a rotary shaft 109 which is disposed in a main body 105, a parking lock member 107 which is connected to the rotary shaft 109 and rotates, and a parking lock operation unit (150 of FIG. 4) which operates the rotary shaft 109 such that the parking lock member 107 rotates.

Meanwhile, the parking prevention apparatus 100 may further include a communication unit (135 of FIG. 4) which exchanges data with the repeater 70 or the server 300, and a processor which controls the parking lock operation unit (150 of FIG. 4).

First, FIG. 3A shows a case where the parking prevention apparatus 100 operates in the parking lock mode, and the parking lock operation unit (150 of FIG. 4) may operate such that the rotary shaft 109 is positioned in a first direction. In the drawing, it is illustrated that the parking lock member 107 intersects with, particularly, perpendicular to a ground.

Next, FIG. 3B shows a case where the parking prevention apparatus 100 operates in the parking lock cancellation mode, and the parking lock operation unit (150 of FIG. 4) may operate such that the rotary shaft 109 rotates from the first direction and is positioned in a second direction.

Particularly, when the parking lock cancellation signal is received from the server 300 via the communication unit 135, FIG. 3 illustrates that, in the parking prevention apparatus 100, based on the parking lock cancellation signal, the parking lock member 107 is parallel to the ground.

Meanwhile, in the parking lock cancellation mode, as shown in FIG. 3B, in addition to the case where the parking lock cancellation signal is received from the server 300 through the communication unit 135, when an unpermitted vehicle enters without authorization, a sensing unit (130 of FIG. 4) detects this, and is able to temporarily enter the parking lock cancellation mode. This makes it possible to prevent breakage of the unauthorized entry vehicle.

Meanwhile, in such a case, the processor (170 of FIG. 4) of the parking prevention apparatus 100 may control to transmit information on the unauthorized entry vehicle to the server 300.

Accordingly, a parking manager or the like may move to a place where the parking prevention apparatus 100 is positioned, and issue a fine bill for the vehicle.

FIG. 4 is a simplified internal block diagram of a parking prevention apparatus of FIG. 1.

Referring to the drawing, the parking prevention apparatus 100 may include a sensing unit 130, a communication unit 135, a memory 140, a parking lock operation unit 150, an audio output unit 160, a processor 170, and a power supply unit 190. When such components are implemented in practical applications, two or more components may be combined into one component, or one component may be divided into two or more components as necessary.

The sensing unit 130 may detect an entering vehicle. To this end, the sensing unit 130 may include a geomagnetic sensor 132 and an IR sensor 133.

The geomagnetic sensor 132 may detect the orientation of the entering vehicle.

The IR sensor 133 may include an IR transmitter and an IR receiver, and may detect the entering vehicle, based on a difference between a transmission signal and a reception signal.

Meanwhile, based on a sensing signal from the geomagnetic sensor 132 or a sensing signal from the IR sensor 133, the processor 170 may determine that the vehicle is entering. When it is determined that the vehicle is entering, the processor 170 may control the parking lock member 107 to operate in the parking lock cancellation mode.

Meanwhile, the processor 170 may distinguish the type of the entering vehicle based on the sensing signal from the geomagnetic sensor 132 or the sensing signal from the IR sensor 133.

Meanwhile, based on the sensing signal from the geomagnetic sensor 132, the processor 170 may firstly determine that the vehicle is entering. After the first determination, based on the sensing signal from the IR sensor 133, the processor 170 may secondly determine that the vehicle is entering.

Meanwhile, the communication unit 135 may exchange data with the repeater 70 or the server 300. In addition, the communication unit 135 may transmit a beacon signal for reception of the mobile terminal 600.

To this end, the communication unit 135 may include a first communication unit 135a for performing a low-power long range (LoRa) communication with the repeater 70 or the server 300, and a second communication unit 135b for transmitting a beacon signal such as BLE.

For example, the first communication unit 135a may include a LoRa communication module, and the second communication unit 135b may include a Bluetooth module.

Meanwhile, the first communication unit 135a may exchange data with the server 300 through uplink and downlink every first period. For example, the first period may be approximately two minutes. As described above, since data is exchanged with the server 300 every first period, unnecessary power consumption may be reduced.

Meanwhile, the first communication unit 135a may receive the parking availability information from the repeater 70 or the server 300, through the downlink at intervals of the first period.

Meanwhile, during a predetermined time zone corresponding to the parking use time information included in the parking availability information, the first communication unit 135a may exchange data with the server 300 through the uplink and the downlink every second period shorter than the first period. For example, the second period may be approximately 10 seconds.

Meanwhile, the first communication unit 135a may receive the parking lock cancellation signal from the repeater 70 or the server 300, through the downlink at intervals of the second period.

Meanwhile, the second communication unit 135b may transmit a beacon signal including the ID information of the parking prevention apparatus to the outside during a predetermined time zone corresponding to the parking use time information.

The second communication unit 135b may periodically transmit the beacon signal and may transmit the beacon signal at intervals shorter than the second period.

Alternatively, regardless of reception of the parking use time information, the second communication unit 135b may transmit the beacon signal to the outside at intervals of third period and may transmit the beacon signal including the ID information of the parking prevention apparatus to the outside every fourth period which is shorter than the third period, during a predetermined time zone corresponding to the parking use time information.

The memory 140 may store a program for the processing or controlling of the processor 170 in the parking prevention apparatus 100, and may serve to temporarily store the inputted or outputted data.

Further, the memory 140 may store the ID information of the parking prevention apparatus 100.

The parking lock operation unit 150 may operate the rotary shaft 109 so that the parking lock member 107 rotates. To this end, a motor (not shown) or the like may be provided.

Meanwhile, the parking lock operation unit 150 may be operated by a power supplied from a power supply unit 190.

The audio output unit 160 may output various audios related to the operation of the parking prevention apparatus 100.

For example, the audio output unit 160 may output a warning sound when an unpermitted vehicle enters without authorization.

Meanwhile, when a permitted vehicle enters, the audio output unit 160 may output a sound such as parking cost information.

The processor 170 may control the operation of each unit in the parking prevention apparatus 100 to control the overall operation of the parking prevention apparatus 100.

Meanwhile, the processor 170 may control the parking lock member 107 to operate in the parking lock mode, and then control the parking lock member 107 to operate in the parking lock cancellation mode, based on the parking lock cancellation signal received from the repeater 70 or the server 300.

Meanwhile, the processor 170 may receive the parking availability information from the repeater 70 or the server 300, and may control to transmit the beacon signal including the ID information after receiving the parking availability information.

Meanwhile, when receiving the parking availability information from the repeater 70 or the server 300, the processor 170 may extract the parking use time information of the parking availability information, control to communicate with the repeater 70 or the server 300 every first period before the first time zone based on the parking use time information, and control to communicate with the repeater 70 or the server 300 every second period shorter than the first period in the first time zone.

Meanwhile, when the parking lock cancellation signal is included in the signals received from the repeater 70 or the server 300 every second period, the processor 170 may control the parking lock member 107 to operate in the parking lock cancellation mode based on the parking lock cancellation signal.

Meanwhile, the processor 170 may control the parking lock member 107 to operate in the parking lock cancellation mode, when the sensing unit 130 detects the entrance of the vehicle.

Meanwhile, the input unit 185 may include a button or the like for an initialization of the parking prevention apparatus 100 or for an operation input, and the like.

The power supply unit 190 may supply power necessary for the operation of each component under the control of the processor 170.

Meanwhile, the power supply unit 190 may include a battery that stores and outputs a DC power.

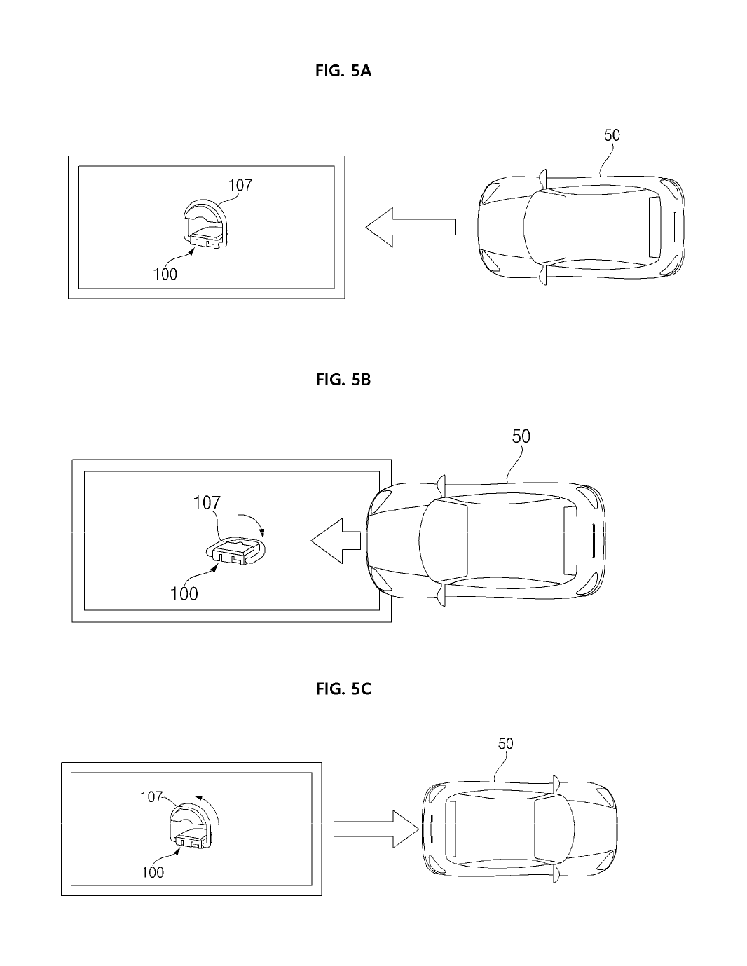

FIG. 5A to FIG. 5C are diagrams for explaining the operation of a parking prevention apparatus.

First, FIG. 5A illustrates that the parking lock member 107 of the parking prevention apparatus 100 operates in the parking lock mode, before the vehicle 50 enters.

Next, FIG. 5B illustrates that the parking lock member 107 of the parking prevention apparatus 100 operates in the parking lock cancellation mode due to the entering of the vehicle 50.

When the parking prevention apparatus 100 receives a parking lock cancellation signal through the communication unit 135 or detects the entering of the vehicle 50 through the sensing unit 130, the parking lock member 107 may operate in the parking lock cancellation mode as shown in FIG. 5B.

Next, FIG. 5C illustrates that the parking lock member 107 of the parking prevention apparatus 100 is returned to the parking lock mode due to departure of the vehicle 50.

The parking prevention apparatus 100 may detect the departure of the vehicle through the sensing unit 130. In this case, as shown in FIG. 5C, the parking lock member 107 may operate in the parking lock mode.

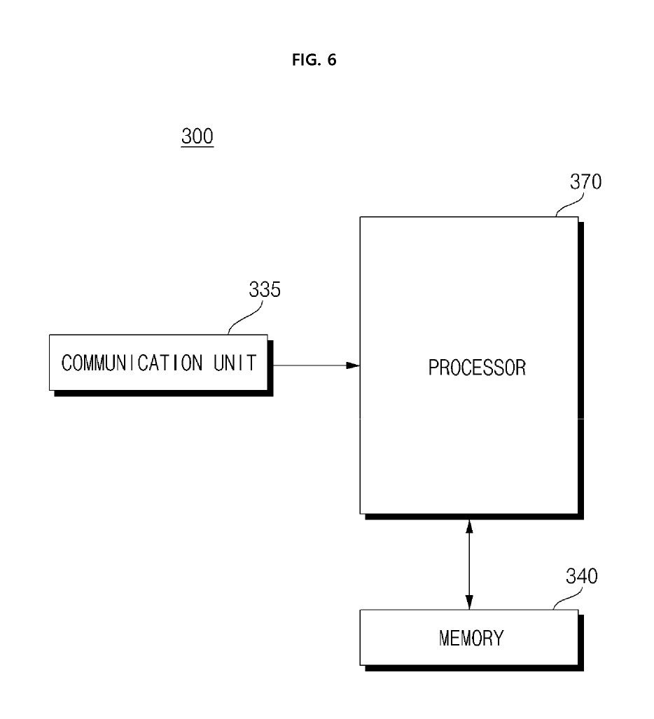

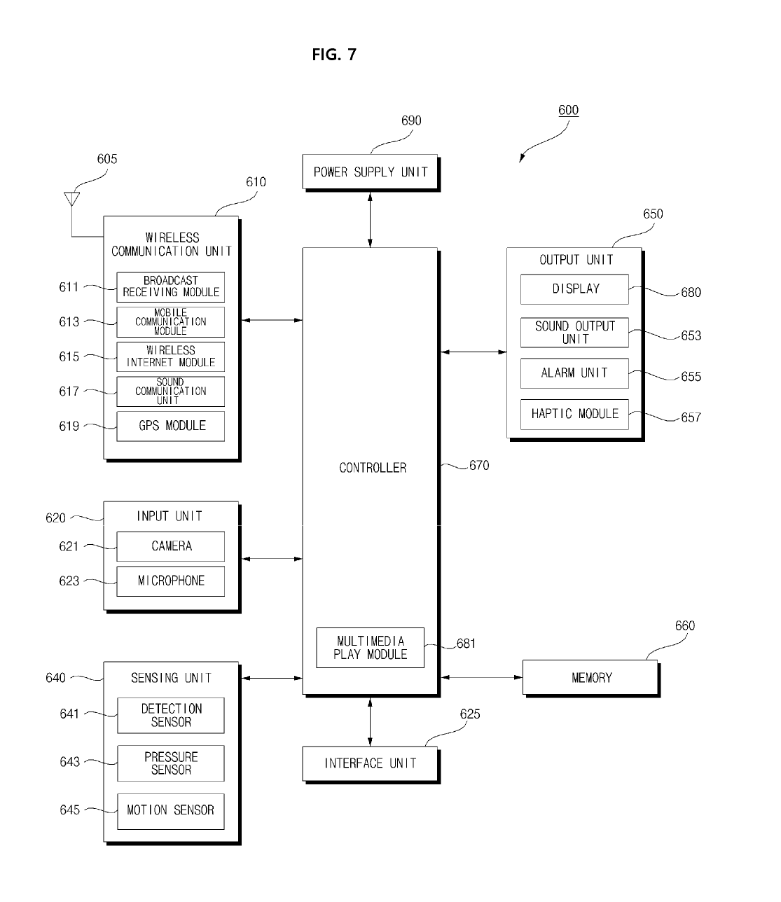

FIG. 6 is a simplified internal block diagram of a server of FIG. 1.

Referring to the drawing, the server 300 may include a communication unit 335, a processor 370, and a memory 340.

The communication unit 335 may communicate with the parking prevention apparatus 100, the control apparatus 400, the second control apparatus 400, the parking manager terminal 420, the mobile terminal 600 of a user of the parking prevention apparatus.

Furthermore, the communication unit 335 may perform communication with the server of a call sensor.

The communication unit 335 may perform a low-power long range (LoRa) communication with the parking prevention apparatus 100.

The communication unit 335 may transmit the parking availability information, a parking lock cancellation signal, and the like to the parking prevention apparatus 100.

Meanwhile, the communication unit 335 may receive ID information and position information from the parking prevention apparatus 100, in the initial operation of the parking prevention apparatus 100.

The ID information and the position information of the parking prevention apparatus may be mapped to a map and stored in the memory 34).

Meanwhile, the communication unit 335 may receive parking availability information from the mobile terminal 600. In addition, payment information may be also received.

Meanwhile, the communication unit 335 may receive the payment information from a payment server (not shown).

Meanwhile, the communication unit 335 may receive the ID information of the parking prevention apparatus 100 from the mobile terminal 600. Accordingly, the communication unit 335 may transmit a parking lock cancellation signal to the parking prevention apparatus 100.

The memory 340 may store a program for the processing or the controlling of the processor 370 in the parking prevention apparatus 300, and may serve to temporarily store the inputted or outputted data.

Meanwhile, the memory 340 may store ID information and the position information with respect to a plurality of parking prevention apparatuses. In particular, the ID information and the position information may be mapped to a map, and be stored.

Meanwhile, the memory 340 may store use information for the parking prevention apparatus, for example, use time information, payment information, and the like.

The processor 370 may control the operation of each unit in the parking prevention apparatus 300 to control the overall operation of the parking prevention apparatus 300.

Meanwhile, when receiving the parking availability information or the like from the mobile terminal 600, the processor 370 may control to transmit the parking availability information to the parking prevention apparatus 100.

Meanwhile, when the ID information of the parking prevention apparatus is received from the mobile terminal 600, the processor 370 may control to transmit a parking lock cancellation signal, or the like to the parking prevention apparatus 100.

Meanwhile, the processor 370 may control the memory 340 to store the ID information and position information for a plurality of parking prevention apparatuses. In particular, the processor 370 may control to map the ID information and the position information to a map, and store.

Meanwhile, the processor 370 may control the memory 340 to store the use information for the parking prevention apparatus, for example, the use time information, the payment information, and the like.

FIG. 7 is an example of an internal block diagram of a mobile terminal of FIG. 1.

Referring to the drawing, the mobile terminal 600 may include a wireless communication unit 610, an audio/video (A/V) input unit 620, an user input unit 630, a sensing unit 640, an output unit 650, a memory 660, an interface unit 625, a controller 670, and a power supply unit 690.

Meanwhile, the wireless communication unit 610 may include a broadcast receiving module 611, a mobile communication module 613, a wireless Internet module 615, a sound communication unit 617, and a GPS module 619.

The broadcast receiving module 611 may receive at least one of a broadcast signal and broadcast related information from an external broadcast management server through a broadcast channel.

The broadcast signal and/or the broadcast related information received through the broadcast receiving module 611 may be stored in the memory 660.

The mobile communication module 613 transmits and receives a wireless signal to/from at least one of a base station, an external terminal, and a server on a mobile communication network. Here, the wireless signal may include various types of data according to a voice call signal, a video call signal, or a text/multimedia message transmission/reception.

The wireless Internet module 615 means a module for wireless Internet access, and the wireless Internet module 615 may be embedded in the mobile terminal 600 or externally provided.

The sound communication unit 617 may perform a sound communication. In a sound communication mode, the sound communication unit 617 may add a predetermined information data to audio data to be outputted, and output a sound. Further, in the sound communication mode, the sound communication unit 617 may extract a predetermined information data from a sound received from the outside.

The global positioning system (GPS) module 619 may receive position information from a plurality of GPS satellites.

The audio/video (A/V) input unit 620 is implemented to input an audio signal or a video signal, and may include a camera 621 and a microphone 623.

The user input unit 630 generates key input data that a user inputs to control the operation of a terminal. To this end, the user input unit 630 may include a key pad, a dome switch, a touch pad (resistive/capacitive), and the like. Particularly, when the touch pad has a mutual layer structure with the display 680, it may be called a touch screen.

The sensing unit 640 may detect the current state of the mobile terminal 600 such as the open/close state of the mobile terminal 600, the position of the mobile terminal 600, the user contact, and the like to generate a sensing signal.

The sensing unit 640 may include a detection sensor 641, a pressure sensor 643, a motion sensor 645, and the like. The motion sensor 645 may detect the movement or the position of the mobile terminal 600 by using an acceleration sensor, a gyro sensor, a gravity sensor, or the like. In particular, the gyro sensor is a sensor for measuring an angular velocity, and may detect the turning direction (angle) with respect to a reference direction.

The output unit 650 may include the display 680, a sound output unit 653, an alarm unit 655, and a haptic module 657, and the like.

The display 680 display to output the information processed in the mobile terminal 600. For example, the display 680 displays the information received from the communication unit 610.

Meanwhile, as described above, when the display 680 and the touch pad have a mutual layer structure to constitute a touch screen, the display 680 may be used as an input apparatus capable of inputting information by a user's touch, in addition to an output apparatus.

The sound output unit 653 outputs audio data received from the wireless communication unit 610 or stored in the memory 660. The sound output unit 653 may include a speaker, a buzzer, and the like.

The alarm unit 655 may output a signal for notifying the occurrence of an event of the mobile terminal 600. For example, a signal may be outputted in a vibration manner.

The haptic module 657 may generate various tactile effects that the user can feel. A typical example of the haptic effect generated by the haptic module 657 is a vibration effect.

The memory 140 may store a program for the processing or controlling of the controller 670, and may serve to temporarily store the inputted or outputted data (e.g., a phone book, a message, a still image, a moving image, and the like).

The interface unit 625 serves as an interface with all external apparatuses connected to the mobile terminal 600. The interface unit 625 may receive the data or power from the external apparatus and transmit to each component in the mobile terminal 600, and may transmit the data in the mobile terminal 600 to the external apparatus.

The controller 670 typically controls the operation of the respective units to control the overall operation of the image display apparatus 600. For example, the controller 670 performs the controlling and processing related to the voice communication, data communication, video call, and the like. In addition, the controller 670 may include a multimedia play module 681 for playing multimedia. The multimedia play module 681 may be configured in hardware inside the controller 670 or in software separately from the controller 670. Meanwhile, the controller 670 may include an application processor (not shown) for operating an application. Alternatively, the application processor (not shown) may be provided separately from the controller 670.

In addition, the power supply unit 690 receives external power and internal power under the control of the controller 670 and supplies power required for operation of the respective components.

Meanwhile, a block diagram of the mobile terminal 600 shown in FIG. 7 is a block diagram for an embodiment of the present invention. Each component of the block diagram may be integrated, added, or omitted according to the specifications of the mobile terminal 600 actually implemented. That is, two or more components may be combined into one component, or one component may be subdivided into two or more components, if necessary. In addition, the functions performed in each block are intended to illustrate the embodiment of the present invention, and the specific operations and apparatuses do not limit the scope of the present invention.

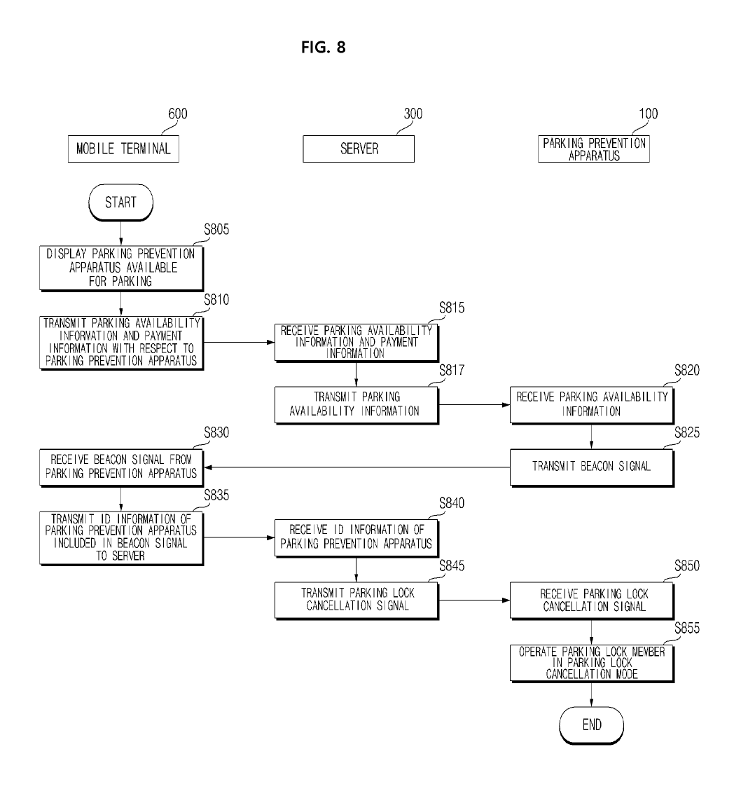

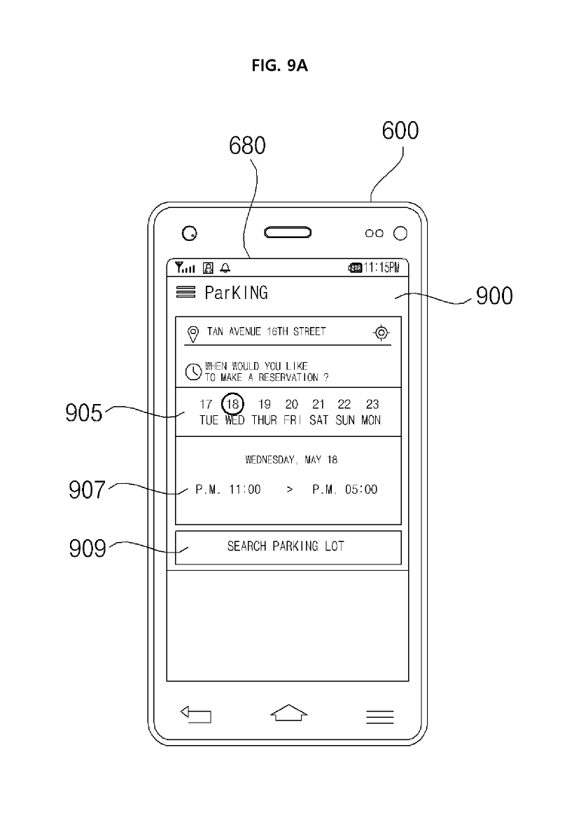

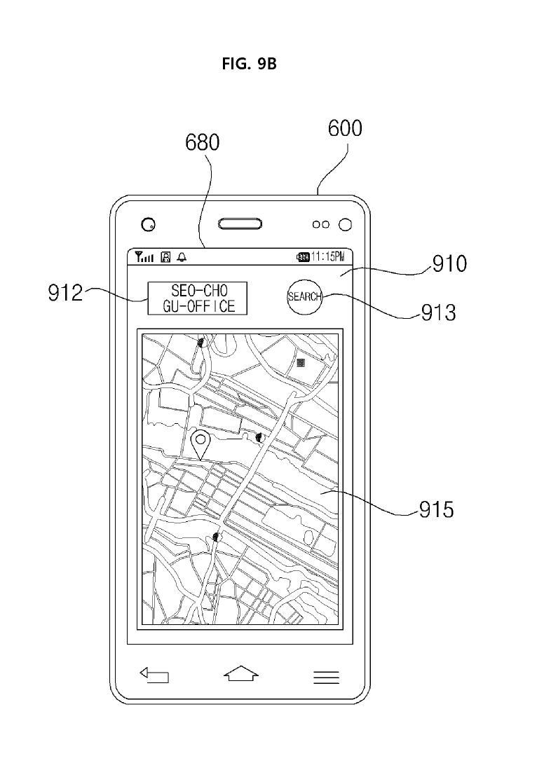

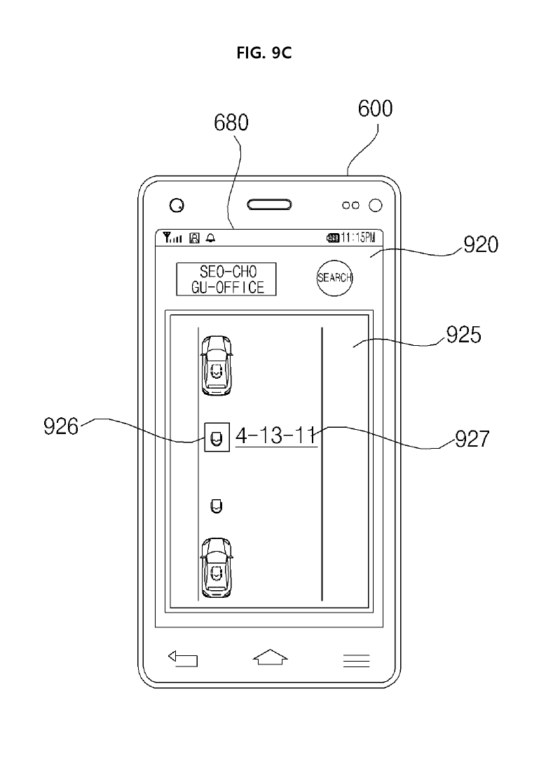

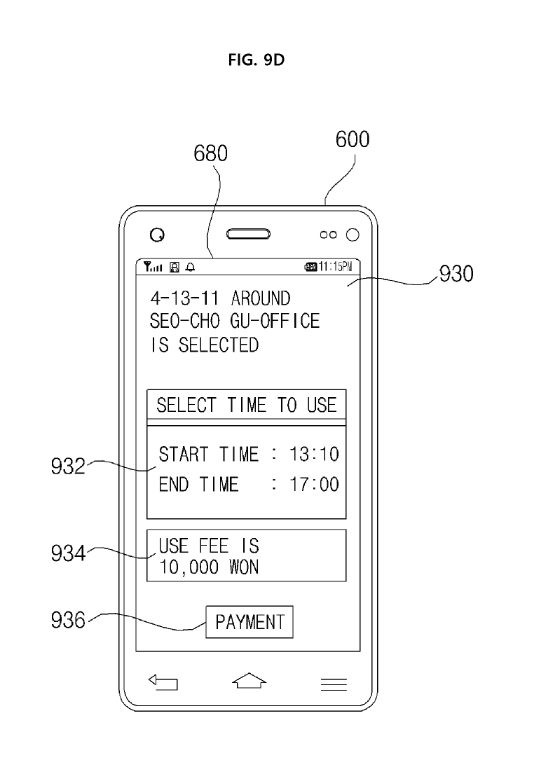

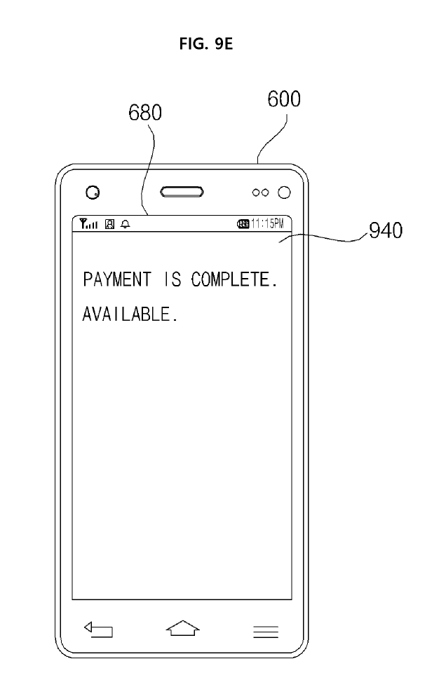

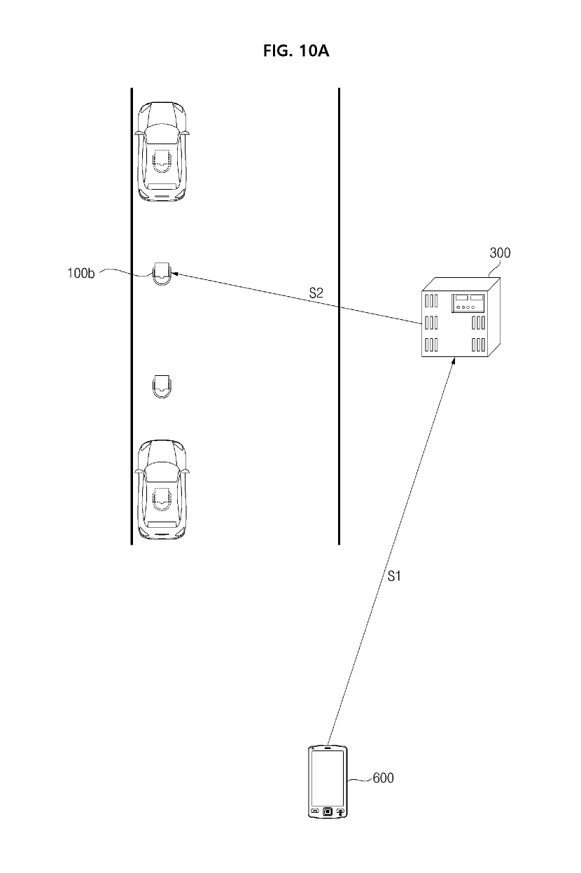

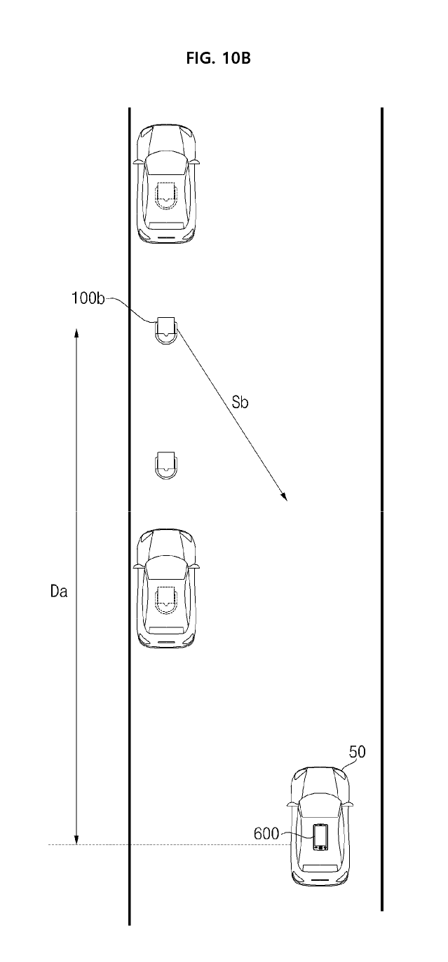

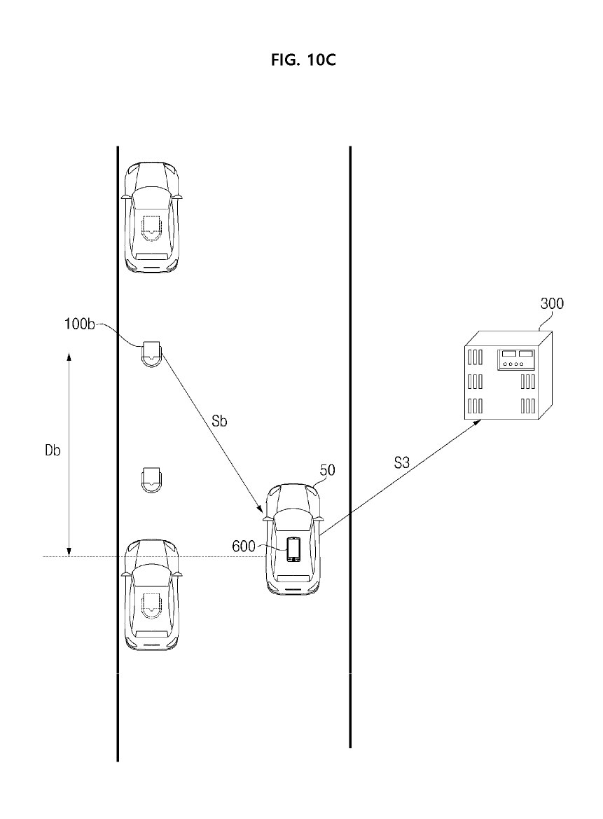

FIG. 8 is a flowchart illustrating an operation method of a parking prevention system according to an embodiment of the present invention, and FIG. 9A to FIG. 11B are diagrams for explaining the operation method of the parking prevention system of FIG. 8.

Referring to FIG. 8, the controller 670 of the mobile terminal 600 may control to execute a parking related application by a user input, and control to display a parking related application screen 900 as shown in FIG. 9A.

The parking related application screen 900 shown in FIG. 9A may include a parking area item, a date designation item 905, a time designation item 907, a parking lot search item 909, and the like.

When the parking lot search item 909 is selected, the controller 670 of the mobile terminal 600 may control to display a screen 910 including a map image 915 and a search window 912 as shown in FIG. 9B.

When a specific area is inputted to the search window 912 and a search execution item 913 is selected, the controller 670 of the mobile terminal 600 may control to display at least one parking prevention apparatus available for parking (S805).

Specifically, when a specific area is inputted to the search window 912 and the search execution item 913 is selected, the controller 670 of the mobile terminal 600 may control to display a screen 920 including a parking area image 925 around the inputted area, as shown in FIG. 9C.

Meanwhile, the parking area image 925 may include a plurality of parking prevention apparatus items (926 and the like), and ID information (927 and the like) of the parking prevention apparatuses, such as 4-13-11.

Meanwhile, the parking area image 925 may include a currently used parking prevention apparatus item and a currently unused parking prevention apparatus item, as shown in FIG. 9C.

Meanwhile, when the unused parking prevention apparatus item 926 is selected, the controller 670 of the mobile terminal 600 may control to display a selected parking prevention apparatus related screen 930 including a use time item 932, a cost item 934, and the like of a corresponding parking prevention apparatus, as shown in FIG. 9D.

That is, when the unused parking prevention apparatus item 926 is selected, the controller 670 of the mobile terminal 600 may control to display the use time information and cost information of the selected parking prevention apparatus together on the display 680.

Meanwhile, the selected parking prevention apparatus related screen 930 may further include a payment item 936.

When the payment item 936 is selected, the controller 670 of the mobile terminal 600 may transmit the payment information to a payment server (not shown).

Meanwhile, when the payment item 936 is selected, the controller 670 of the mobile terminal 600 may control to display a payment completion screen 940, as shown in FIG. 9E.

Meanwhile, when the payment is completed, the controller 670 of the mobile terminal 600 may control to transmit the parking availability information for the selected parking prevention apparatus to the server 300 (S810).

At this time, when the payment is completed, the controller 670 of the mobile terminal 600 may control to transmit the parking availability information and the payment information for the selected parking prevention apparatus together to the server 300.

Meanwhile, the parking availability information may include parking use time information and selected parking prevention apparatus information.

Next, the server 300 may receive parking availability information and payment information from the mobile terminal 600 (S815). Then, the server 300 may transmit the parking availability information to the selected parking prevention apparatus 100 (S817). In particular, the parking availability information may be transmitted to the selected parking prevention apparatus 100 by using a low-power long range (LoRa) communication.

Accordingly, the parking prevention apparatus 100 may receive the parking availability information from the server 300 or the repeater 70 (S820).

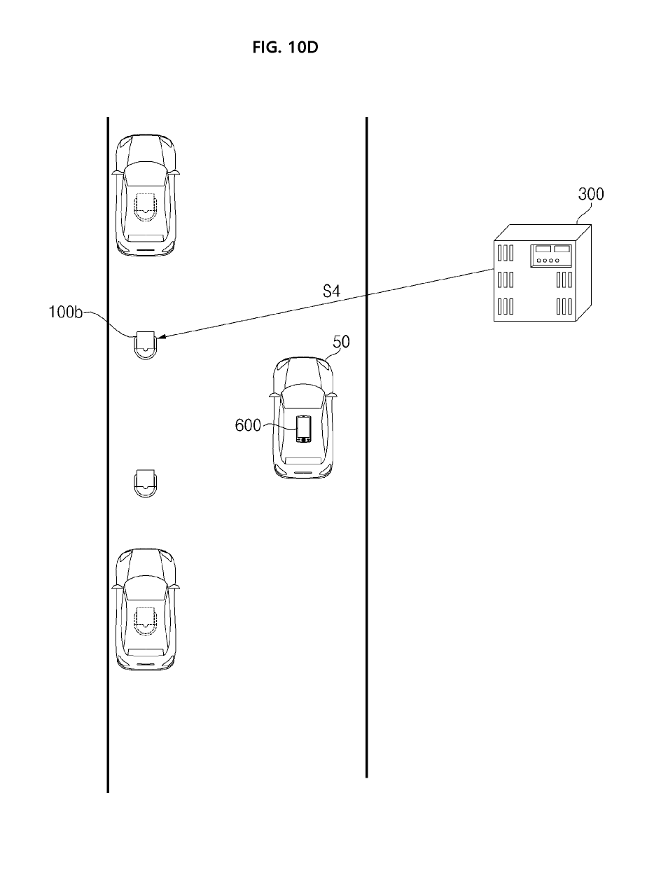

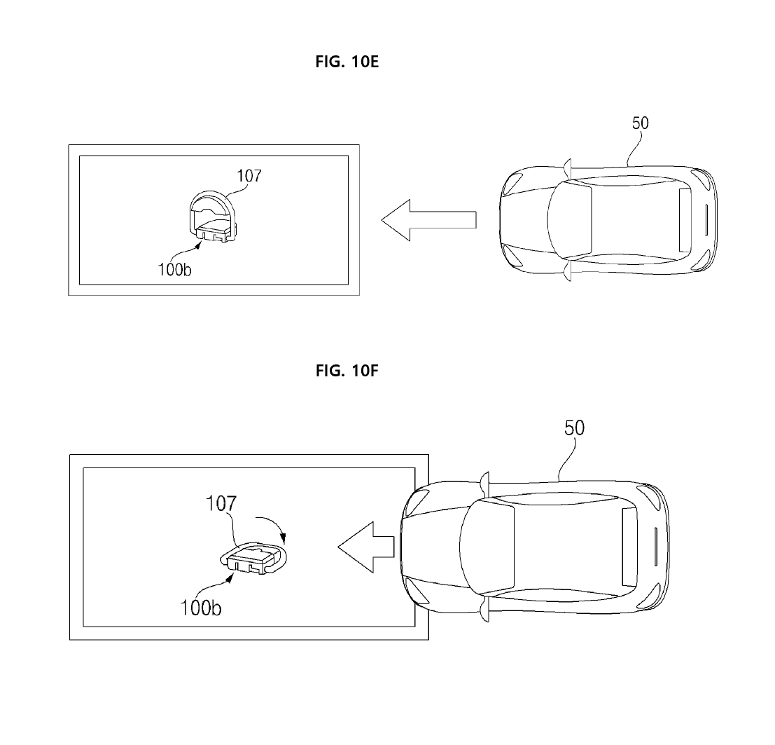

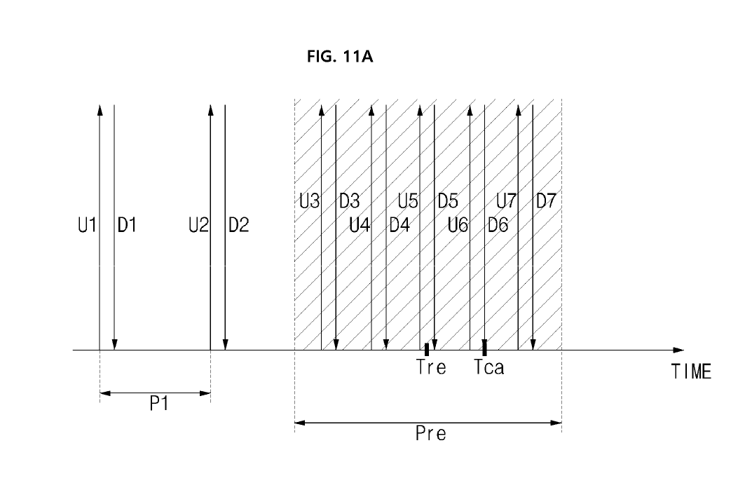

Meanwhile, FIG. 10A shows that the mobile terminal 600 transmits a signal S1 including the parking availability information and the like to the server 300. In response, the server 300 transmits a signal S2 including the parking availability information and the like to the selected parking prevention apparatus 100.

The processor 170 of the parking prevention apparatus 100 may transmit a beacon signal including the ID information to the outside (S825).

Particularly, the processor 170 of the parking prevention apparatus 100 may extract the parking use time information among the parking availability information received through the communication unit 135.

In addition, the processor 170 of the parking prevention apparatus 100 may control to transmit a beacon signal including the ID information of the parking prevention apparatus 100 to the outside during a predetermined time zone corresponding to the parking use time information.

FIG. 10B illustrates that the parking prevention apparatus 100 outputs a beacon signal Sb. However, the distance to the vehicle 50 operated by the owner of the mobile terminal 600 is Da, and the beacon signal Sb is not able be received by the mobile terminal 600.

FIG. 10C illustrates that the parking prevention apparatus 100 continuously outputs the beacon signal Sb, the distance to the vehicle 50 of the owner of the mobile terminal 600 is Db, and the beacon signal Sb is received by the mobile terminal 600.

Accordingly, the controller 670 of the mobile terminal 600 may receive the beacon signal including the ID information through the communication unit 610 (S830).

In addition, the controller 670 of the mobile terminal 600 may extract the ID information from the beacon signal.

Then, the controller 670 of the mobile terminal 600 may control to transmit the ID information of the parking prevention apparatus 100 to the server 300 (S835).

FIG. 10C illustrates that after receiving the beacon signal Sb, the mobile terminal 600 transmits a signal S3 including the ID information of the parking prevention apparatus 100 to the server 300.

Accordingly, the server 300 receives the ID information of the parking prevention apparatus 100 from the mobile terminal 600 (S840). Then, the server 300 may transmit a parking lock cancellation signal S4 to the parking prevention apparatus 100 (S845), as shown in FIG. 10D.

Particularly, when receiving the ID information of the parking prevention apparatus 100 from the mobile terminal 600, the server 300 may recognize that a corresponding vehicle approaches the parking prevention apparatus 100, and may immediately transmit a parking lock cancellation signal to the parking prevention apparatus 100.

Next, the processor 170 of the parking prevention apparatus 100 may receive the parking lock cancellation signal through the communication unit 135, particularly, the first communication unit 135a (S850).

Then, the processor 170 of the parking prevention apparatus 100 may control the parking lock member 107 to operate in a parking lock cancellation mode (S855).

Meanwhile, FIG. 10E illustrates that the parking lock member 107 of the parking prevention apparatus 100 operates in the parking lock mode, before receiving the parking lock cancellation signal.

Next, FIG. 10Fb illustrates that the parking lock member 107 of the parking prevention apparatus 100 operates in the parking lock cancellation mode due to the entry of the vehicle 50 after the parking lock cancellation signal. Accordingly, the safely permitted vehicle may be parked in the parking area. In particular, parking is possible under an unmanned automated system.

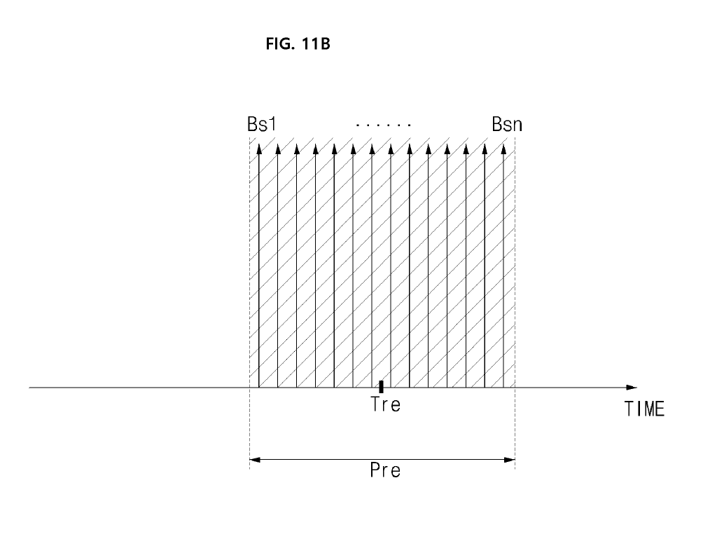

Meanwhile, FIG. 11A is a diagram for explaining data communication with the server 300 in the first communication unit 135a of the parking prevention apparatus 100.

The first communication unit 135a of the parking prevention apparatus 100 may exchange data with the server 300 through uplink U1, U2 and downlink D1, D2, every first period P1. For example, the first period P1 may be approximately two minutes. As described above, since data is exchanged with the server 300 every first period (P1), unnecessary power consumption may be reduced.

Meanwhile, the first communication unit 135a of the parking prevention apparatus 100 may receive the parking availability information from the repeater 70 or the server 300, through the downlink D1, D2 of the first period P1 interval.

Meanwhile, the first communication unit 135a of the parking prevention apparatus 100 may exchange data with the server 300 through uplinks U3 to U7 and downlinks D3 to D7 every second period P2 which is shorter than the first period P1, during a predetermined time zone (Pre) corresponding to the parking use time information included in the parking availability information. For example, the second period P2 may be approximately 10 seconds.

Meanwhile, the first communication unit 135a of the parking prevention apparatus 100 may receive the parking lock cancellation signal from the repeater 70 or the server 300, through the downlink at intervals of the second period P2.

In the drawing, it is illustrated that a reserved parking use start time is Tre, but it is illustrated that the actual time when the parking lock cancellation signal is received is Tca, not Tre.

When the vehicle arrives later than a scheduled time, the reserved parking use start time may be different from the time when the parking lock cancellation signal is received.

Next, FIG. 11B is an example of a timing chart of the beacon signal outputted from the second communication unit 135b of the parking prevention apparatus 100.

Meanwhile, the second communication unit 135b of the parking prevention apparatus 100 may transmit a beacon signal (Bs1˜Bsn) including the ID information of the parking prevention apparatus 100 to the outside, during a predetermined time zone corresponding to the parking use time information.

The second communication unit 135b of the parking prevention apparatus 100 may periodically transmit a beacon signal, and may transmit the beacon signal at a shorter interval than the second period P2.

Meanwhile, unlike the drawing, the second communication unit 135b of the parking prevention apparatus 100 may transmit a beacon signal to the outside at intervals of a third period irrespective of reception of parking use time information, and may transmit a beacon signal including the ID information of the parking prevention apparatus 100 to the outside every fourth period shorter than the third period, during a predetermined time zone corresponding to the parking use time information.

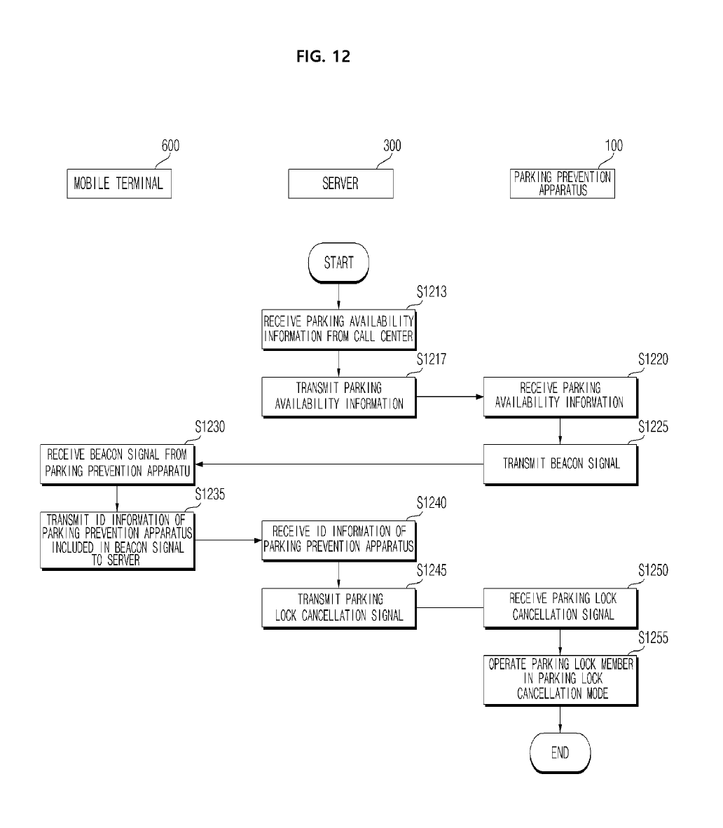

FIG. 12 is a flowchart illustrating an operation method of a parking prevention system according to another embodiment of the present invention.

Meanwhile, the operation method of FIG. 12 is similar to that of FIG. 8, but there is a difference in that steps 805 to 810 of FIG. 8 performed in the mobile terminal 600 are not performed.

When an application using the parking prevention apparatus 100 is not installed in the mobile terminal 600, a user may call a public office or the like having a right to the parking management apparatus 100.

Accordingly, a call center received the call may transmit the parking availability information to the server 300. Accordingly, the server 300 may receive the parking availability information from the call center (S1213).

Then, the server 300 may transmit the parking availability information to a corresponding parking prevention apparatus 100 (S1217).

Steps 1217 to 1255 (S1217˜S1255) are the same as steps 817 to 855 (S817˜S855) of FIG. 8. Accordingly, a description thereof will be omitted with reference to FIG. 8 and the like.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

1. A parking prevention apparatus comprising:
a rotary shaft disposed in a main body;
a parking lock member connected to the rotary shaft and to rotate;
a parking lock operation unit to operate the rotary shaft for rotating the parking lock member;
a communication unit to exchange data with a repeater or a server; and
a processor to control the parking lock member to operate in a parking lock mode and, based on a parking lock cancellation signal received from the repeater or the server, to control the parking lock member to operate in a parking lock cancellation mode.

2. The parking prevention apparatus of claim 1, wherein the processor controls to receive parking availability information from the repeater or server, and transmit a beacon signal including ID information after receiving the parking availability information.

3. The parking prevention apparatus of claim 2, wherein the communication unit comprises a first communication unit for receiving the parking lock cancellation signal, and a second communication unit for transmitting the beacon signal.

4. The parking prevention apparatus of claim 2, wherein the processor controls to extract parking use time information from the parking availability information when receiving the parking availability information from the repeater or server, perform communication with the repeater or the server every first period before a first time zone based on the parking use time information, and communicate with the repeater or the server every second period shorter than the first period in the first time zone.

5. The parking prevention apparatus of claim 4, wherein the processor controls the parking lock member to operate in the parking lock cancellation mode, based on the parking lock cancellation signal, when the parking lock cancellation signal is included in a signal received from the repeater or server every second period.

6. The parking prevention apparatus of claim 1, further comprising a sensing unit for detecting an entering vehicle,
wherein the processor controls the parking lock member to operate in the parking lock cancellation mode, when the vehicle enters.

7. The parking prevention apparatus of claim 6, wherein the sensing unit comprises a geomagnetic sensor and an IR sensor,
wherein the processor determines whether the vehicle enters, based on a sensing signal from the geomagnetic sensor or a sensing signal from the IR sensor, and controls the parking lock member to operate in the parking lock cancellation mode, when it is determined that the vehicle enters.

8. The parking prevention apparatus of claim 7, wherein the processor firstly determines that the vehicle enters, based on the sensing signal from the geomagnetic sensor, and secondly determines that the vehicle enters, based on the sensing signal from the IR sensor after the first determination.

9. A mobile terminal comprising:
a display;
a communication unit to exchange data with a server; and
a controller to control to display at least one parking prevention apparatus available for parking on the display based on selection signal, transmit parking availability information to the server when any one of the at least one parking prevention apparatus is selected, and transmit ID information to the server when receiving a beacon signal including the ID information from the selected parking prevention apparatus.

10. The mobile terminal of claim 9, wherein the controller controls to transmit parking availability information and payment information to the server, when payment is completed, after any one of the at least one parking prevention apparatus is selected.

11. The mobile terminal of claim 9, wherein the parking availability information comprises parking use time information and selected parking prevention apparatus information.

12. The mobile terminal of claim 9, wherein the controller controls to display use time information and cost information of the selected parking prevention apparatus together on the display, when any one of the at least one parking prevention apparatus is selected.

13. A parking prevention system comprising:
a mobile terminal to transmit parking availability information for using any one of at least one parking prevention to the outside;
a server to transmit the parking availability information when receiving the parking availability information from the mobile terminal, and transmit a parking lock cancellation signal when receiving ID information of the parking prevention apparatus from the mobile terminal; and
a parking prevention apparatus to transmit a beacon signal when receiving the parking availability information from the server or a repeater, and operate a parking lock member in a parking lock cancellation mode when receiving a parking lock cancellation signal from the server or the repeater.

14. The parking prevention system of claim 13, wherein the mobile terminal extracts ID information included in the beacon signal and transmits the ID information to the server, when receiving the beacon signal from the parking prevention apparatus.

15. The parking prevention system of claim 13, wherein the server transmits the parking availability information to the mobile terminal, when receiving the parking availability information from a call center.

16. The parking prevention system of claim 13, wherein the parking prevention apparatus extracts parking use time information from the parking availability information when receiving the parking availability information from the repeater or server, performs communication with the repeater or the server every first period, before a first time zone based on the parking use time information, and communicates with the repeater or server every second period shorter than the first period in the first time zone.
